(19) United States
(12) Patent Application Publication
(10) Pub. No.: US 2026/0072330 A1
(43) Pub. Date: Mar. 12, 2026

(54) APPARATUS FOR DRIVING IRIS

(71) Applicant: JAHWA electronics Co., Ltd., Chungcheongbuk-do (KR)

(72) Inventors: IN SOO KIM, Chungcheongbuk-do (KR); HEE SEUNG KIM, Chungcheongbuk-do (KR); KI HOON JEON, Chungcheongbuk-do (KR)

(21) Appl. No.: 19/259,237

(22) Filed: Jul. 3, 2025

(30) Foreign Application Priority Data
Jul. 24, 2024 (KR) 10-2024-0097864

(51) Int. Cl. G03B 9/06

(52) U.S. Cl. CPC G03B 9/06

(57) ABSTRACT

An apparatus for driving an iris according to an embodiment includes a rotator configured to rotate based on a stator, a plurality of blades connected to the stator and the rotator and configured to rotate by the rotation of the rotator, first rails respectively provided on the stator and the rotator to face each other and having an arc shape, the first rails having a vertical cross section of a V shape, a plurality of first balls arranged between the first rails, and a guiding unit arranged between the stator and the rotator in an area where the first ball is not arranged.

### CROSS-REFERENCE TO RELATED APPLICATION AND CLAIM OF PRIORITY

This application claims the benefit under 35 USC § 119 of Korean Patent Application No. 10-2024-0097864 filed on Jul. 24, 2024, in the Korean Intellectual Property Office, the entire disclosure of which is incorporated herein by reference for all purposes.

### BACKGROUND

### 1. Technical Field

The present disclosure relates to an apparatus for driving an iris, and more specifically, to an apparatus for driving an iris in which the driving precision is further improved by improving the structure supporting the rotational movement.

### 2. Background Art

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

Camera modules or devices mounted on mobile terminals, etc. may be equipped with an aperture (module, device) that controls the amount of light entering the lens. This aperture is also called an iris (IRIS) because it performs a function similar to the iris of the eye.

The aperture (device for driving an iris) has various driving methods depending on the embodiment, but is generally driven in a way that, if one or more blades having a wing shape physically move (rotate), the degree of opening and closing in front of the lens is changed by the movement, thereby controlling the amount of light entering the lens.

A device for driving an iris is a device that controls the amount of light entering a lens by controlling a blade located at the front end of the lens to move (rotate) to a specific position based on a user's selection or an automated setting, and the device for driving an iris may be implemented as an independent device, or to be integrated with a device or actuator that implements AF or/and OIS functions.

A device in which the amount of light entering the lens is precisely controlled by controlling the direction and amount of movement of the blade using an electromagnetic force or magnetic force between the coil and the magnet as well as operations such as ON/OFF operations for opening and closing or discontinuous step-by-step adjustment is also disclosed.

In the case of a conventional device for driving an iris, a magnet is installed on one of a moving body (carrier, rotator, etc.) and a fixed body (housing, base, stator, etc.), and a coil is installed on the other, and the moving body to which blades are linked by an electromagnetic or magnetic force between them is configured to rotate.

In the conventional device for driving an iris, a ball (ball bearing) is interposed between the moving body and the fixed body to reduce friction and improve driving precision. Specifically, rails having an arc shape or track shape are formed on each of the moving body and the fixed body, and balls are arranged between these rails.

In order to horizontally support the rotator (moving body), etc., three or more rails are installed on each of the rotator and the stator, and balls are usually placed between the facing rails.

When a ball is placed between rails whose vertical cross sections have a V shape, the ball may continuously maintain point-contact with the rail, and the ball is placed so that a part thereof is accommodated in each of the rails. Thus, when the moving body moves linearly, its linear movement may be accurately guided.

However, in the device for driving an iris, the rotator (moving body) does not move linearly but rotates around the common center of the rails, and it is practically impossible to exactly match the curvature radii of three or more rails, so the ball may actually act as a load on the rotation of the rotator.

Due to these problems, the rotator may move intermittently instead of continuously, or the rotator may move upwards above the ball, causing the rotator to deviate from its original position or to tilt relative to the horizontal direction.

In the conventional device for driving an iris, in order to avoid this problem, a rail with a complex structure in which the balls face each other in an oblique or diagonal direction is applied, or a U-shaped rail with a clearance between the ball and the rail is applied.

However, since the conventional device for driving an iris is fundamentally based on a method of leaving a clearance between the ball and the rail so that the ball does not act as a load on the rotational motion of the rotator, it is impossible to avoid the phenomenon of the rotator slightly deviating from the center of rotation (decentering), which may lower the driving precision.

### SUMMARY

The present disclosure is designed to solve the problems of the related art, and therefore the present disclosure is directed to providing an apparatus for driving an iris, which may further improve the precision of driving by improving the rail structure for physically supporting the rotator and guiding the rotational motion, and a camera module including the same.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

An apparatus for driving an iris may include a rotator configured to rotate based on a stator; a plurality of blades connected to the stator and the rotator and configured to rotate by the rotation of the rotator; first rails respectively provided on the stator and the rotator to face each other and having an arc shape, the first rails having a vertical cross section of a V shape; a plurality of first balls arranged between the first rails; and a guiding unit arranged between the stator and the rotator in an area where the first ball is not arranged.

Specifically, the guiding unit of the present disclosure may include second rails respectively provided on the stator and the rotator to face each other; and a second ball arranged on the second rail.

In addition, the first and second rails of the present disclosure may be provided at positions symmetrical to each other.

Furthermore, one of the second rails respectively provided on the stator and the rotator may have a vertical cross section of a V shape, and the other may have a vertical cross section of a U shape.

Depending on an embodiment, an arc distance between balls located at both ends among the plurality of first balls the present disclosure may be greater than a rotational movement distance of the rotator.

In addition, the plurality of first balls of the present disclosure may include balls having a plurality of diameters.

Preferably, the apparatus for driving an iris according to the present disclosure may further include a third ball arranged between the stator and the rotator, and in this case, wherein one of the stator and the rotator may include a pocket portion in which the third ball is accommodated, and the pocket portion of the present disclosure may be located between the first rail and the second rail.

In addition, it is preferable that the second ball is provided in a number smaller than the number of the plurality of the first ball.

According to a preferred embodiment of the present disclosure, the phenomenon of the rotator deviating from the center of rotation or tilting may be fundamentally resolved through a simple structural change of the rail and adaptive arrangement of the balls.

In addition, according to the present disclosure, since a plurality of balls are arranged between V-shaped rails facing each other and point-contact between the balls and the rails may be continuously maintained, the rotational motion of the rotator is accurately guided, thereby further increasing the driving precision.

According to an embodiment of the present disclosure, since balls are arranged between V-shaped rails in a sufficient number to sufficiently cover the moving distance or angle caused by rotation of the rotator, tilt of the rotator may be prevented in itself, and design diversity may be implemented by minimizing the number of balls arranged on the opposite rail, etc.

According to an embodiment of the present disclosure, since balls having a plurality of diameters are arranged alternately between, for example, V-shaped rails, rotational instability due to tolerance accumulation, etc. may be resolved, and the load that may occur during rotational movement of the rotator may be minimized, thereby improving driving efficiency.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a drawing showing the overall configuration of an apparatus for driving an iris according to a preferred embodiment of the present disclosure,

FIG. 2 is a drawing for illustrating the connection relationship between a stator, a rotator, and a blade shown in FIG. 1,

FIGS. 3 and 4 are drawings for illustrating the stator and the rotator according to a preferred embodiment of the present disclosure,

FIGS. 5A and 5B are drawings showing the change in size of an opening through which light enters by the blade linked to the rotation of the rotator,

FIG. 6 is a cross-sectional view for illustrating the mutual relationship between a rail, a guide rail, and a ball according to an embodiment of the present disclosure, and

FIGS. 7 to 9 are drawings for illustrating the arrangement relationship of the rail and the ball according to embodiments of the present disclosure.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

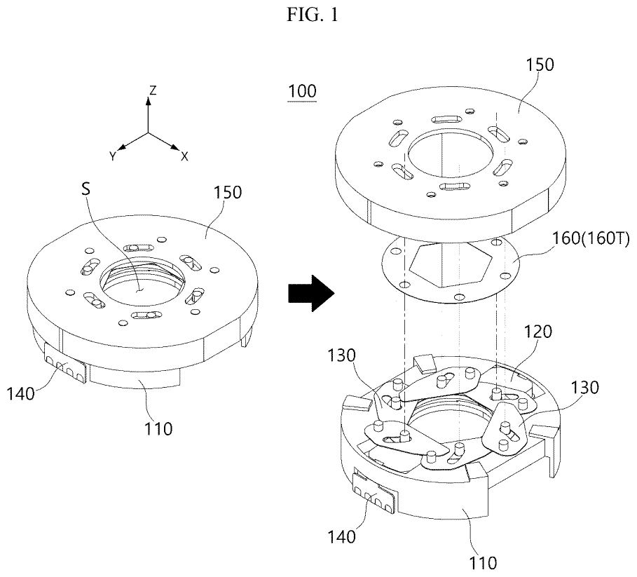

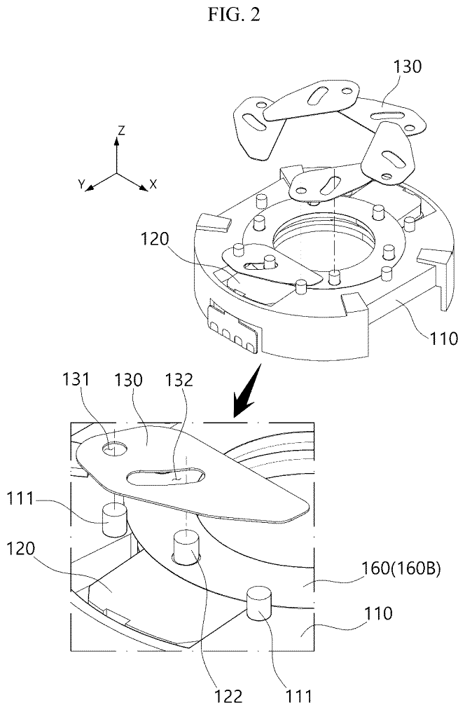

FIG. 1 is a drawing showing the overall configuration of an apparatus 100 for driving an iris (hereinafter, referred to as a ‘driving apparatus’) according to a preferred embodiment of the present disclosure, and FIG. 2 is a drawing for illustrating the connection relationship between a stator 110, a rotator 120, and a blade 130 shown in FIG. 1.

First, the overall configuration and function of the driving apparatus 100 according to the present disclosure will be described, and the structure of rails R1, R2, GR1, GR2, which are one of the main features of the present disclosure, and balls B1, B2, which are adaptively arranged in this structure, will be described later in detail.

The driving apparatus 100 of the present disclosure may be implemented as an independent device, or may be implemented in an actuator in which the AF function and/or the OIS function are implemented singly or integrally, or may be implemented as a component of a camera module in which these are combined.

The driving apparatus 100 of the present disclosure may be positioned in front of a lens (not shown) based on the direction in which light enters the lens (optical axis direction, Z-axis direction based on the drawing), and is configured to control the amount of light (light quantity) entering the lens by varying the degree of opening and closing of the space (opening) through which light enters the lens according to the size and direction in which the blade 130 rotates as described below.

It is obvious that the axes depicted in the drawings, terms referring to the axes, and terms such as upper portion, lower portion, front, rear, vertical, horizontal, etc., described with respect to the axes are only intended to present relative standards for describing embodiments of the present disclosure, and are not intended to specify any direction or position on an absolute basis, and may of course vary relatively depending on the position of the target object, the position or direction of view, etc.

In the following description, the present disclosure will be described with the Z-axis as the reference for the up-down or vertical direction, and, from a corresponding viewpoint, the present disclosure will be described with the X-axis as the reference for the front or rear, and the Y-axis as the reference for the left or right.

As illustrated in the drawings, the driving apparatus 100 of the present disclosure may be configured to include a stator 110, a rotator 120, a blade 130, a magnet M, and a coil C.

The stator 110 of the present disclosure is a configuration corresponding to the basic frame of the driving apparatus 100 and functions as a relative fixed body of the rotating rotator 120.

The rotator 120 of the present disclosure is a moving body that rotates with the stator 110 as a relative fixed body, and as illustrated in the drawings, the rotator 120 is mounted on the upper portion of the stator 110 and corresponds to a moving body that rotates using the electromagnetic force (magnetic force) between the magnet M installed in the rotator 120 and the coil C1 installed in the stator 110 as a driving force.

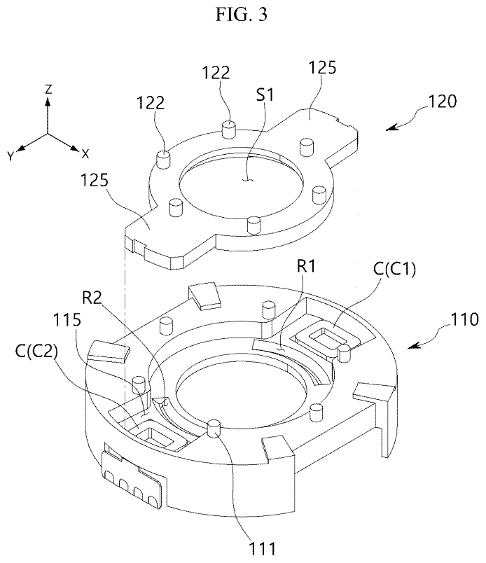

The rotator 120 may be formed in a kind of track shape in the center portion of which an opening S1 is formed as illustrated in the drawings, etc. The opening S1 (see FIG. 3) formed in the center portion is formed at a position corresponding to the lens based on the optical axis direction, and the size or shape of the opening S1 may be designed so as to be a factor that determines the maximum amount of light entering the lens when the blade 130 moves outward to the maximum.

The blade 130 of the present disclosure may be provided in plurality, and each blade 130 has a rotation hole 131 and a slot 132.

The rotation hole 131 of the blade 130 is fitted into the fixed shaft 111 provided in the stator 110, and the slot 132 of the blade 130 has a long hole shape as illustrated in the drawings and is fitted into the link shaft 122 provided in the rotator 120.

The rotator 120 of the present disclosure corresponds to a moving body that is mounted on the stator 110 and rotates as described above, and from a corresponding viewpoint, the stator 110 corresponds to a fixed body. Therefore, the fixed shaft 111 formed on the stator 110 functions as a rotary shaft of the blade 130, and the link shaft 122 formed on the rotator 140 functions as a moving shaft that transmits the rotation driving force to the blade 130.

When the rotator 120 rotates, the link shaft 122 provided to the rotator 120 also rotates, and since this link shaft 122 is coupled to the slot 132 of the blade 130, the link shaft 122 transmits a driving force to the blade 130 along the guiding space provided by the slot 132 of the blade 130, and the blade 130 rotates by the driving force.

The spacer 160 not only physically supports the blade 130, but also guides the movement (XY plane) of the blade 130 in the horizontal direction (XY plane), and in particular, the upper spacer 160 prevents the blade 130 from lifting or tilting in the upward direction (Z-axis direction).

The spacer 160, which may be made of a track-shaped plate, may specifically include a lower spacer 160B positioned between the blade 130 and the stator 110, and an upper spacer 160T positioned above the blade 130, which is fitted into the stator 110.

The case 150, which protects the internal structure and functions as a shield can, may be coupled to the stator 110, and an opening S may be formed in the center portion to allow light to enter from a subject as illustrated in the drawings.

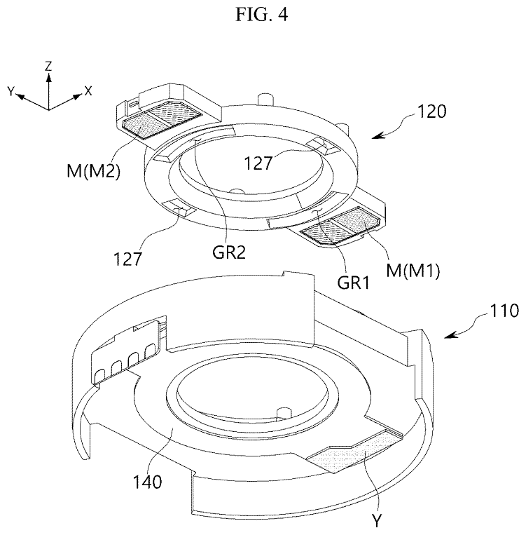

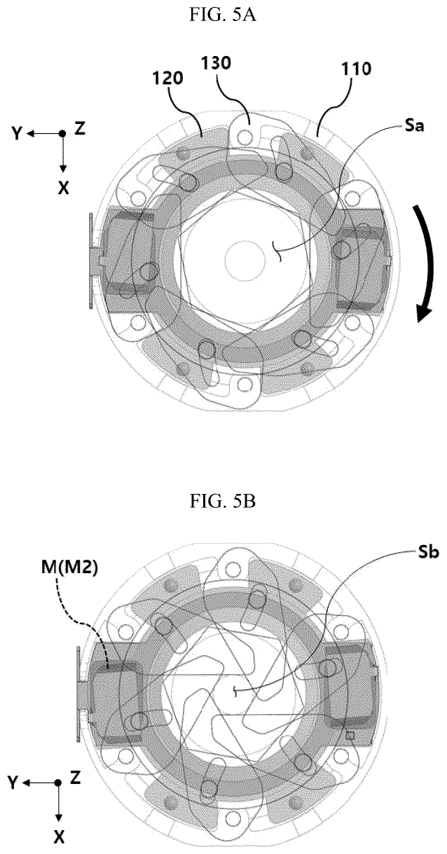

FIGS. 3 and 4 are drawings for illustrating the stator 110 and the rotator 120 according to a preferred embodiment of the present disclosure, and FIGS. 5A and 5B are drawings showing the change in size of openings Sa, Sb through which light enters by the blade 130 linked to the rotation of the rotator 120.

As shown in the drawings, in order to prevent detachment of the rotator 120 and set a range of movement, the rotator 120 may include a protrusion 125 that protrudes outwardly from the rotator 120 and is placed in a moving space 115 formed in the stator 110.

The driving unit that rotates the rotator 120 may be implemented in various applications such as shape memory alloy (SMA), piezoelectric element, and micro electro mechanical system (MEMS), as long as it can move the rotator 120 in a specific direction using an external control signal or a detected signal system.

However, considering the efficiency of device miniaturization, power consumption, noise suppression, space utilization, rotational behavior, precision control, etc., it is desirable that the driving unit is implemented with a configuration that utilizes the electromagnetic force (magnetic force) generated between the magnet and the coil.

Specifically, the driving unit according to a preferred embodiment of the present disclosure may include a magnet provided in any one of the rotator 120, which is a moving body, and the stator 110, which is a fixed body, and a coil provided in the other among the rotator 120 and the stator 110 in which a magnet is not provided.

In order to more simply implement electrical wiring relationships and physical coupling structures, it is desirable that the magnet M is installed on the rotator 120, which is a moving body, and the coil C1 is installed on the stator 110, which is a fixed body.

In order to disperse the driving force and increase the efficiency of the rotation driving force, etc., it is preferable that the driving magnets are implemented as a plurality of magnets M1, M2 provided at positions that are symmetrical to each other, as illustrated in the drawings. From a corresponding viewpoint, the driving coils may also be implemented as a plurality of coils C1, C2 so as to face the magnets, respectively.

When current is supplied to the first coil C1 and/or the second coil C2, an electromagnetic force (magnetic force) according to the magnitude and direction of the supplied current is generated between the first coil C1 and the first magnet M1 and between the second coil C2 and the second magnet M2, and the rotator 120 rotates by the generated driving force with the stator 110 as a relative fixed body.

If the rotator 120 rotates in this way, the blade 130, which is linked to the rotation of the rotator 120, rotates, so the degree of opening and closing of the space (opening) through which light enters the lens is changed according to the size and direction of rotation of the blade 130, thereby controlling the amount of light (light quantity) entering the lens.

FIG. 5A shows a state in which the space (opening) Sa through which light flows toward the lens is expanded, and FIG. 5B below shows a state in which the space (opening) Sb through which light flows toward the lens is relatively closed as the blade 130 rotates clockwise with the fixed shaft 111 as a rotary shaft in conjunction with the movement of the rotator 120 that rotates clockwise.

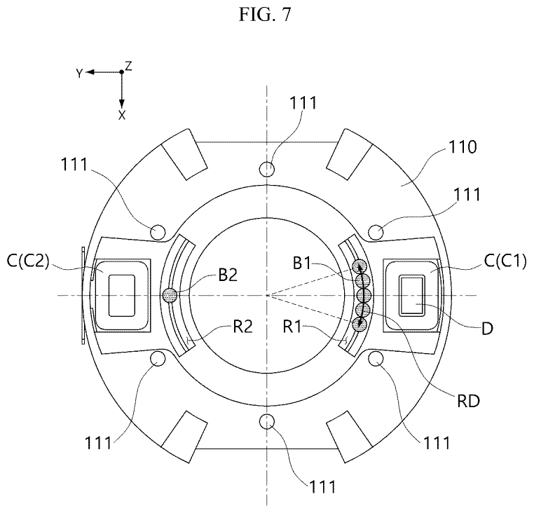

According to an embodiment, a hall sensor for detecting the position the of magnets M1, M2 or sensing magnets, and an operation drive D (see FIG. 7) for controlling the magnitude and direction of current supplied to the coils C1, C2 using a signal output by the hall sensor may be included. The hall sensor is typically implemented in the form of a single electronic component (chip) integrated with the operation drive D, and thus is not illustrated separately in the drawings.

The first coil C1, the second coil C2, the operation drive D, etc. may be mounted on the circuit board 140, and it is preferable that the circuit board 140 is configured so that a portion thereof is exposed to the outside for interfacing with external modules, power supplies, external devices, etc.

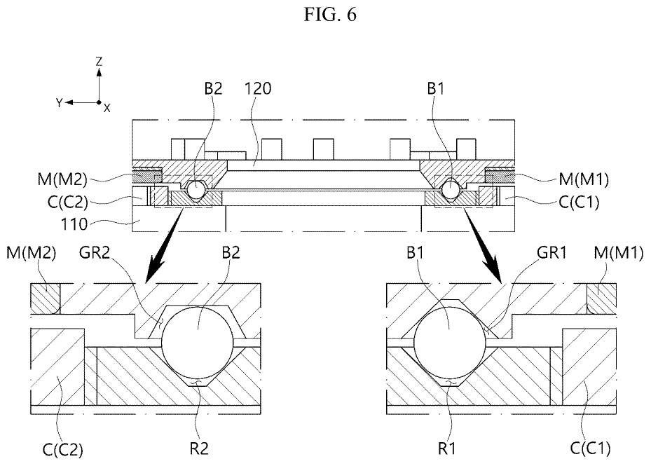

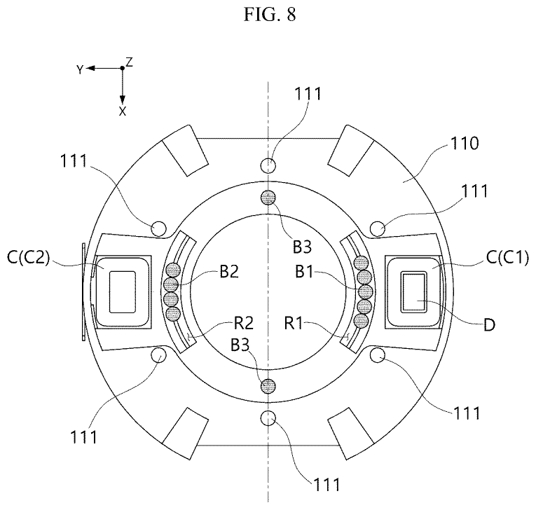

FIG. 6 is a cross-sectional view for illustrating the mutual relationship between rails R1, R2, guide rails GR1, GR1, and balls B1, B2 according to an embodiment of the present disclosure, and FIGS. 7 to 9 are drawings for illustrating the arrangement relationship of the rails R1, R2 and the balls B1, B2, B3 according to embodiments of the present disclosure.

As illustrated in FIGS. 3 and 6, the first rails having an arc shape are provided on the stator 110 and the rotator 120, respectively, to face each other. In the following description, in order to relatively distinguish the first rail provided on the stator 110 and the first rail provided on the rotator 120, the first rail provided on the rotator 120 is referred to as a first guide rail GR1.

The stator 110 of the present disclosure is equipped with a first rail R1 having a round shape, and the rotator 120 is equipped with a first guide rail GR1 facing the first rail R1, and a plurality of first balls B1 are arranged between the first rail R1 and the first guide rail GR1.

In order to effectively guide the rotation of the rotator 120, it is desirable that the first rail R1 and the first guide rail GR1 have an arc shape with the same radius of curvature.

As shown in FIG. 7, it is preferable that the arc distance RD (hereinafter referred to as a ‘first arc distance’) between the balls located at both ends among the plurality of first balls B1 is greater than the entire rotational angular range or the entire rotational movement distance of the rotator 120.

For example, if the rotational movement distance of the rotator 120 is ‘7” (unit omitted), the first arc distance may be designed to be ‘10’, which is greater than ‘7’, and in this case, ‘five’ first balls B1 with a diameter of 2 may be provided.

It is desirable that the first rail R1 and the first guide rail GR1 are configured to be longer than the first arc distance within a range that has a margin so that the movement of the first ball B1 may be performed to a certain degree of freedom.

The first ball B1 is arranged such that a part thereof is accommodated in the first rail R1 and/or the first guide rail GR1. Since the first rail R1 and the first guide rail GR1 have a vertical cross section in a ‘V shape’ (one of them is an inverted V shape), a plurality of first balls B1 are configured to make point-contact with the first rail R1 and the first guide rail GR1, respectively.

Here, the vertical cross section being formed in a ‘V shape’ means that it is not only in the form of V as the alphabet shape, but also in a shape where the first ball B1 contacts the inner surface of the rail (first rail R1 and first guide rail GR1) at two points as shown in FIG. 6.

In the embodiment of the present disclosure, the rotator 120 may be guided to rotate accurately in place without tilt or decentering through the physical support and guiding of the first ball B1, the first rail R1, and the first guide rail GR1.

In addition, as described above, since a plurality of first balls B1 are provided so that the ‘first arc distance’ (arc distance between the first balls B1 provided at both ends) is greater than the rotational movement distance of the rotator 120 and are arranged between the rotator 120 and the stator 110, the horizontal balance of the rotator 120 may be maintained with only a single pair of rails (rails facing each other).

That is, according to the present disclosure, horizontal balance may be maintained even if three or more rail pairs are not provided as in the prior art, and above all, the problems of the prior art in which the rotator cannot rotate accurately due to tolerances such as the radius of curvature of three or more rails not exactly matching (intermittent movement, tilt, decentering, etc.) may be fundamentally resolved.

Depending on the embodiment, a guiding unit for preventing inclining (tilting) of the rotator 120 may be provided in an area opposite to the area where the first ball B1 is not provided, for example, the area where the first rail R1 or the first guide rail GR1 is provided (with respect to the XY plane), thereby allowing the horizontal balance of the rotator 120 to be maintained more effectively.

The guiding unit is a configuration placed between the stator 110 and the rotator 120, and may be implemented with a protruding member, a ball, a round-shaped bar, etc. having a height corresponding to the gap between the rotator 120 and the stator 110, and depending on the embodiment, the guiding unit may be implemented with a structure of a rail and a ball so that the rotational movement of the rotator 120 may be guided more flexibly.

Specifically, the guiding unit may include second rails respectively provided on the stator 110 and the rotator 120 to face each other, and a second ball B2 arranged between the second rails. In the following description, in order to relatively distinguish the second rail provided on the stator 110 and the second rail provided on the rotator 120, the second rail provided on the rotator 120 is referred to as a second guide rail GR2.

In this case, it is desirable that the first rail R1 and the second rail R2 are provided at positions symmetrical to each other so that the horizontal balance of the rotator 120 may be effectively maintained. In this configuration, the first guide rail GR1 facing the first rail R1 and the second guide rail GR2 facing the second rail R2 are also provided at positions symmetrical to each other.

If the vertical cross sections of the second rail R2 and the second guide rail GR2 are all formed in a ‘V shape’, problems in the prior art may arise due to the tolerance with the first rail R1, etc.

Therefore, it is desirable that one of the second rail R2 and the second guide rail GR2 is configured to have a vertical cross section of a V shape, and the other is configured to have a vertical cross section of a U shape.

Here, the vertical cross section being formed in a ‘U shape’ means that it may be formed in a shape including not only the alphabet U shape but also a trapezoidal shape, etc., and that the groove size of the rail (either the second rail R2 or the second guide rail GR2) may be configured to be slightly larger than the diameter of the second ball B2.

According to an embodiment, a third ball B3 arranged between the stator 110 and the rotator 120 may be further included. In this case, one of the stator 110 and the rotator 120 includes a pocket portion 127 (see FIG. 4) having a shape such as a groove, rail, etc. for accommodating the third ball B3 to prevent external detachment of the third ball B3.

In order to effectively implement horizontal balance and power distribution of driving force, as long as the pocket portion 127 is provided in the stator 110, the pocket portion 127 in which the third ball B3 is accommodated is preferably provided between the first rail R1 and the second rail R2, at an outer periphery corresponding to the radius of curvature of the first rail R1, or at an outer side rather than the outer periphery.

If the pocket portion 127 is provided on the rotator 120, the pocket portion 127 may be provided between the first guide rail GR1 and the second guide rail GR2, at an outer periphery corresponding to the radius of curvature of the first guide rail GR1 or at a further outer position thereof.

The second ball B2 according to an embodiment of the present disclosure may be provided in a smaller number than the number of the first balls B1 as shown in FIG. 7. As described above, the rotation of the rotator 120 is guided by the first ball B1 arranged between the rails, i.e., the first rail R1 and the first guide rail GR1, where grooves having an end of a V shape are continuously formed.

Therefore, even if the number of the second ball B2 for horizontal balance, etc. is smaller than the number of the first balls B1, the second ball B2 may be perform its function at least sufficiently, and also, in the range where horizontal balance, etc. can be maintained for frictional force or load reduction, it is more desirable as the number of the second ball B2 is smaller.

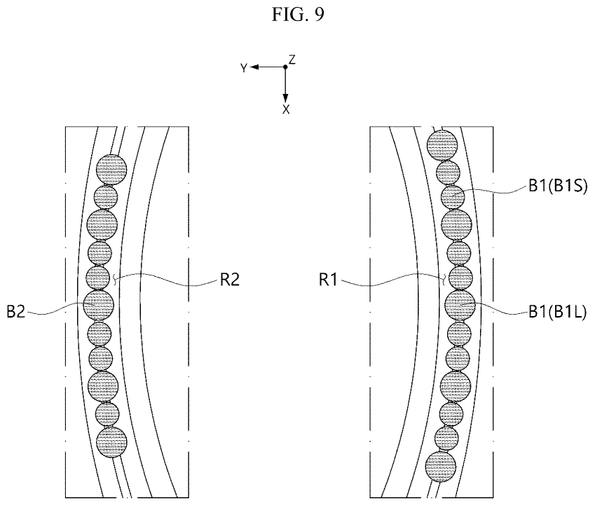

Meanwhile, the first balls B1 of the present disclosure may include balls having a plurality of diameters, as shown in FIG. 9. It is preferable that the first balls B1 are arranged alternately in an appropriate number according to the size of the diameter. FIG. 9 illustrates two types of first balls B1S, B1L having two different diameters.

In this embodiment of the present disclosure, the rotational guiding of the rotator 120 is induced to be achieved by the first ball B1L having a large diameter, and the first ball B1S having a relatively small diameter may form an appropriate gap variably between the first balls B1L having a large diameter, and further, it is possible to reduce not only the frictional force due to contact between the first ball B1L and the first ball B1L but also the frictional force due to the self-rotation or movement of the first ball B1L, thereby further improving the characteristics of the rotational drive.

According to an embodiment, the stator 110 of the present disclosure may be equipped with a yoke Y (see FIG. 4) made of a magnetic material to generate an attractive force with the magnet M installed in the rotator 120, etc.

If an attractive or suction force is generated between the magnets M1, M2 and the yoke Y, the rotator 120 comes into close contact with the stator 110 (in the Z-axis direction based on the drawings) with the balls B1, B2 being interposed between the stator 110 and the rotator 120, so that physical contact may continue between the balls B1, B2 and the rotator 120, as well as between the balls B1, B2 and the stator 110.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

What is claimed is:

1. An apparatus for driving an iris, comprising:
a stator;
a rotator configured to rotate based on the stator;
a plurality of blades connected to the stator and the rotator and configured to rotate by the rotation of the rotator;
first rails respectively provided on the stator and the rotator to face each other and having an arc shape, the first rails having a vertical cross section of a V shape;
a plurality of first balls arranged between the first rails; and
a guiding unit arranged between the stator and the rotator in an area where the first ball is not arranged.

2. The apparatus for driving an iris according to claim 1, wherein the guiding unit includes:
second rails respectively provided on the stator and the rotator to face each other; and
a second ball arranged on the second rail.

3. The apparatus for driving an iris according to claim 2, wherein the first and second rails are provided at positions symmetrical to each other.

4. The apparatus for driving an iris according to claim 2, wherein one of the second rails respectively provided on the stator and the rotator has a vertical cross section of a V shape, and the other has a vertical cross section of a U shape.

5. The apparatus for driving an iris according to claim 1, wherein an arc distance between balls located at both ends among the plurality of first balls is greater than a rotational movement distance of the rotator.

6. The apparatus for driving an iris according to claim 1, wherein the plurality of first balls include balls having a plurality of diameters.

7. The apparatus for driving an iris according to claim 2, further comprising:
a third ball arranged between the stator and the rotator,
wherein one of the stator and the rotator includes a pocket portion in which the third ball is accommodated.

8. The apparatus for driving an iris according to claim 7, wherein the pocket portion is located between the first rail and the second rail.

9. The apparatus for driving an iris according to claim 2, wherein the second ball is provided in a number smaller than the number of the plurality of the first ball.
